(19) United States
(12) Patent Application Publication
(10) Pub. No.: US 2019/0340184 A1
(43) Pub. Date: Nov. 7, 2019

(54) SYSTEM AND METHOD FOR MANAGING CONTENT PRESENTATIONS

(71) Applicant: Cognant LLC, Mountain View, CA (US)

(72) Inventors: Heng Wang, San Jose, CA (US); Hao Zhao, Fremont, CA (US); Bhargav Bhushanam, Mountain View, CA (US); Ishan Upadhyaya, Mountain View, CA (US); Owen S. Vallis, Santa Clara, CA (US); Arun Kejariwal, Fremont, CA (US); Daniel Gelman, Palo Alto, CA (US); James Koh, Pasadena, CA (US)

(21) Appl. No.: 16/386,485

(22) Filed: Apr. 17, 2019

Related U.S. Application Data
(60) Provisional application No. 62/666,275, filed on May 3, 2018.

(51) Int. Cl. G06F 16/26; G06F 16/21; G06F 8/61

(52) U.S. Cl. CPC G06F 16/26; G06F 8/61; G06F 16/219

(57) ABSTRACT

A method, a system, and an article are provided for managing content presentations on a plurality of client devices. An example computer-implemented method includes: obtaining data including a record of the content presentations; aggregating the data to generate a history of content presentations for each client device; providing the history of content presentations for each client device to a plurality of weighting algorithms configured to calculate weights for the content presentations; combining the weights from each weighting algorithm for each client device; attributing, based on the combined weights for each client device, a user action taken on the client device to at least one of the content presentations; and facilitating an adjustment of future content presentations based on the attribution.

### CROSS-REFERENCE TO RELATED APPLICATIONS

This application claims the benefit of U.S. Provisional Patent Application No. 62/666,275, filed May 3, 2018, the entire contents of which are incorporated by reference herein.

### BACKGROUND

The present disclosure relates generally to managing digital content presentations on client devices and, in certain examples, to systems and methods for attributing user action to one or more content presentations and adjusting future content presentations based on the attribution.

In general, client devices are capable of presenting a wide variety of content, including images, video, audio, games, and combinations thereof. Such content can be stored locally on client devices and/or can be sent to the client devices from server computers over a network (e.g., the Internet). To watch an online movie, for example, a user of a client device can download a copy of the movie and/or can stream the movie from a content provider. Online content can be provided to client devices by publishers, such as websites and software applications.

Users can interact with content in various ways. A user can, for example, view images, listen to music, or play computer games. With certain online content, a user can select the content or a portion thereof and be directed to a website where further content can be presented or obtained. In some instances, users can download or receive content in the form of software applications.

### SUMMARY

In general, the subject matter of this disclosure relates to managing content presentations on a plurality of client devices. A record of content presentations on the client devices can be aggregated by client device, to generate a history of content presentations for each client device. The history of content presentations for a client device can be processed using a set of weighting algorithms. Each weighting algorithm can be configured to calculate a weight for each content presentation in the history of content presentations. Each weight can provide an indication of an influence that the respective content presentation had on a user of the client device. The weights can be combined (e.g., using ensemble learning) to determine an attribution value for each content presentation in the history of content presentations. The attribution value for a content presentation can be or include, for example, an indication of how effective the content presentation was at encouraging the user to take an action on the client device. Future content presentations can be adjusted based on the attribution values and/or the weights.

Advantageously, the systems and methods described herein can provide an accurate assessment of the effectiveness of content presentations on user client devices. For example, when multiple content presentations encourage a user to take an action (e.g., install or use a software application), it can be difficult to determine the influence that each content presentation had on the user and/or how effectively each content presentation encouraged the user to take the action. The systems and methods described herein can solve this problem by using a plurality of weighting algorithms that assign weights to the content presentations. Each weighting algorithm preferably uses a unique or distinct approach for assigning the weights, for example, based on times at which items of content were presented, indications of fraud (e.g., by content publishers), and/or content types (e.g., videos or images). The weights are then combined (e.g., using ensemble learning) to determine attribution values for each content presentation, preferably in a manner that considers a relative importance or significance of each weighting algorithm. In this way, the user action can be attributed to multiple content presentations. Compared to previous approaches, for example, the systems and methods described herein are able to provide a more accurate assessment of the influence of each content presentation in a sequence of content presentations.

In one aspect, the subject matter described in this specification relates to a computer-implemented method. The method includes: obtaining data including a record of content presentations on a plurality of client devices; aggregating the data to generate a history of content presentations for each client device from the plurality of client devices; providing the history of content presentations for each client device to a plurality of weighting algorithms, wherein each weighting algorithm is configured to calculate a weight for each content presentation in the history of content presentations, and wherein each weight includes an indication of an influence the content presentation had on a user of the client device; combining the weights from each weighting algorithm for each client device; attributing, based on the combined weights for each client device, a user action taken on the client device to at least one of the content presentations; and facilitating an adjustment of future content presentations based on the attribution.

In certain examples, the data can include an identification of an item of content and a time at which the identified item of content was presented on a client device from the plurality of client devices. The data can include an identification of user interactions with the content presentations. At least one weighting algorithm from the plurality of weighting algorithms can be configured to calculate at least one of the weights according to a time difference between at least one of the content presentations and the user action taken on the client device. At least one weighting algorithm from the plurality of weighting algorithms can be configured to calculate at least one of the weights according to a time difference between a first content presentation and a last content presentation in the history of content presentations.

In some instances, at least one weighting algorithm from the plurality of weighting algorithms can be configured to calculate the weight for each content presentation according to an indication of fraud associated with the content presentation. At least one weighting algorithm from the plurality of weighting algorithms can be configured to calculate the weight for each content presentation according to a type of content associated with the content presentation, and wherein the type of content includes one of image content, video content, or playable content. Combining the weights can include: assigning a significance to each weighting algorithm; and combining the weights according to the assigned significance for each weighting algorithm. The user action can include initiating a software installation on the client device. Attributing the user action to at least one of the content presentations can include determining a fractional attribution for each content presentation in the at least one of the content presentations, wherein the fractional attribution includes an indication of how much the content presentation in the at least one of the content presentations influenced the user to take the action.

In another aspect, the subject matter described in this specification relates to a system having one or more computer processors programmed to perform operations including: obtaining data including a record of content presentations on a plurality of client devices; aggregating the data to generate a history of content presentations for each client device from the plurality of client devices; providing the history of content presentations for each client device to a plurality of weighting algorithms, wherein each weighting algorithm is configured to calculate a weight for each content presentation in the history of content presentations, and wherein each weight includes an indication of an influence the content presentation had on a user of the client device; combining the weights from each weighting algorithm for each client device; attributing, based on the combined weights for each client device, a user action taken on the client device to at least one of the content presentations; and facilitating an adjustment of future content presentations based on the attribution.

In some examples, the data can include an identification of an item of content and a time at which the identified item of content was presented on a client device from the plurality of client devices. The data can include an identification of user interactions with the content presentations. At least one weighting algorithm from the plurality of weighting algorithms can be configured to calculate at least one of the weights according to a time difference between at least one of the content presentations and the user action taken on the client device. At least one weighting algorithm from the plurality of weighting algorithms can be configured to calculate at least one of the weights according to a time difference between a first content presentation and a last content presentation in the history of content presentations.

In certain implementations, at least one weighting algorithm from the plurality of weighting algorithms can be configured to calculate the weight for each content presentation according to an indication of fraud associated with the content presentation. At least one weighting algorithm from the plurality of weighting algorithms can be configured to calculate the weight for each content presentation according to a type of content associated with the content presentation, and wherein the type of content includes one of image content, video content, or playable content. Combining the weights can include: assigning a significance to each weighting algorithm; and combining the weights according to the assigned significance for each weighting algorithm. The user action can include initiating a software installation on the client device. Attributing the user action to at least one of the content presentations can include determining a fractional attribution for each content presentation in the at least one of the content presentations, wherein the fractional attribution includes an indication of how much the content presentation in the at least one of the content presentations influenced the user to take the action.

In another aspect, the subject matter described in this specification relates to an article. The article includes a non-transitory computer-readable medium having instructions stored thereon that, when executed by one or more computer processors, cause the computer processors to perform operations including: obtaining data including a record of content presentations on a plurality of client devices; aggregating the data to generate a history of content presentations for each client device from the plurality of client devices; providing the history of content presentations for each client device to a plurality of weighting algorithms, wherein each weighting algorithm is configured to calculate a weight for each content presentation in the history of content presentations, and wherein each weight includes an indication of an influence the content presentation had on a user of the client device; combining the weights from each weighting algorithm for each client device; attributing, based on the combined weights for each client device, a user action taken on the client device to at least one of the content presentations; and facilitating an adjustment of future content presentations based on the attribution.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for managing content presentations on client devices.

FIG. 2 is a schematic data flow diagram of an example system for attributing user action to content presentations on client devices.

FIG. 3 is a schematic timeline for a history of content presentations on a client device.

FIG. 4 is a schematic timeline for a history of content presentations on a client device.

FIG. 5 is a plot of an example weighting function for determining weights associated with a plurality of content presentations on client devices.

FIG. 6 is a flowchart of an example method of managing content presentations on client devices.

### DETAILED DESCRIPTION

In general, the subject matter of this disclosure relates to assessing and managing digital content presentations by a group of publishers (e.g., websites and/or software applications) on client devices. Users of the client devices can be exposed to or can interact with the content and can take various actions, such as installing a software application, in response to the content. When such an action is attributed to a specific publisher, the publisher can receive compensation. This can incentivize publishers to achieve the attribution and compensation. Some publishers, for example, may engage in fraudulent activity (e.g., “software installation fraud”) by generating fake or phony clicks on one or more client devices, and/or providing an indication that fake or phony clicks have occurred on the one or more client devices. Such fraud is estimated to result in losses of about $8 billion annually, and these losses are projected to increase.

In certain instances, users can interact with websites and software applications through a variety of commands on the user client devices. For example, users can select items on a touch screen for a graphical user interface or can enter characters using a keyboard. In some examples, a “click” can refer to an action taken by a user to select an item presented on a display, such as a computer screen, a computer monitor, or a mobile device display. A click can be, for example, a mouse click, a tap on a touch screen (e.g., with a finger or stylus), or a press of a button (e.g., on a keyboard or other input device). Other types of clicks are possible.

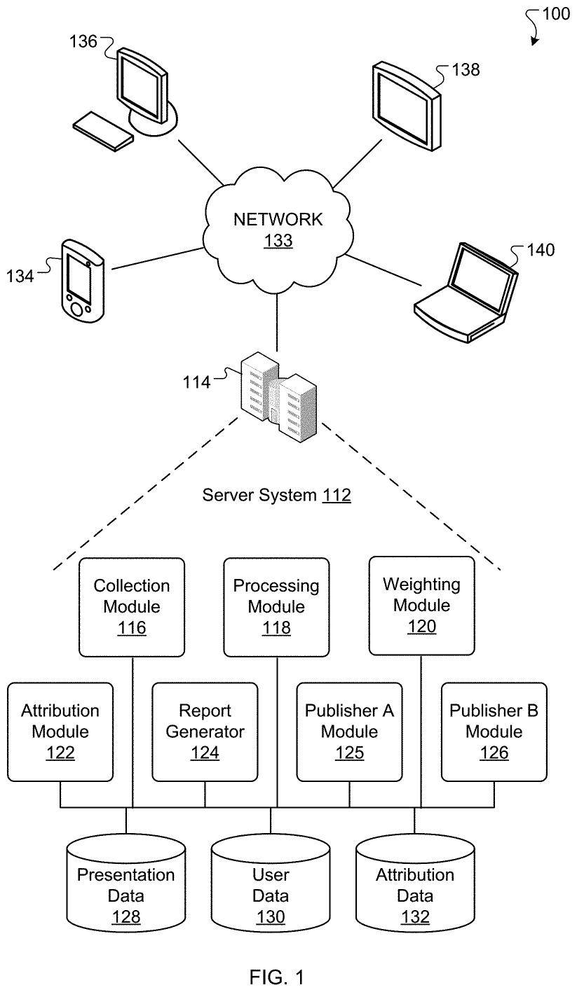

FIG. 1 illustrates an example system 100 for managing digital content presentations on a plurality of client devices. A server system 112 provides functionality for collecting and processing data related to the content presentations and for managing future content presentations based on an analysis of the data. The server system 112 includes software components and databases that can be deployed at one or more data centers 114 in one or more geographic locations, for example. In certain instances, the server system 112 is, includes, or utilizes a content delivery network (CDN). The server system 112 software components can include a collection module 116, a processing module 118, a weighting module 120, an attribution module 122, a report generator 124, a publisher A module 125, and a publisher B module 126. The software components can include subcomponents that can execute on the same or on different individual data processing apparatus. The server system 112 databases can include a presentation data 128 database, a user data 130 database, and an attribution data 132 database. The databases can reside in one or more physical storage systems. The software components and data will be further described below.

An application, such as, for example, a web-based application, can be provided as an end-user application to allow users to interact with the server system 112. The client application or components thereof can be accessed through a network 133 (e.g., the Internet) by users of client devices, such as a smart phone 134, a personal computer 136, a tablet computer 138, and a laptop computer 140. Other client devices are possible. In alternative examples, the presentation data 128 database, the user data 130 database, the attribution data 132 database, or any portions thereof can be stored on one or more client devices. Additionally or alternatively, software components for the system 100 (e.g., the collection module 116, the processing module 118, the weighting module 120, the attribution module 122, the report generator 124, the publisher A module 125, and the publisher B module 126) or any portions thereof can reside on or be used to perform operations on one or more client devices.

FIG. 1 depicts the collection module 116, the processing module 118, the weighting module 120, the attribution module 122, the report generator 124, the publisher A module 125, and the publisher B module 126 as being able to communicate with the presentation data 128 database, the user data 130 database, and the attribution data 132 database. The presentation data 128 database generally includes information related to digital content presentations on the client devices. Such information can include, for example, copies of digital content (e.g., images, videos, audio, computer games, text, messages, and/or offers) and records of the digital content presentations and user interactions with the digital content presentations. The records can include, for example, a client device identifier (also referred to as device ID), an IP address (e.g., for a client device), a device geographical location (e.g., city, state, and/or country), a user agent identifier (e.g., a browser identifier), a timestamp (e.g., corresponding to a time at which the installation occurred), a publisher identifier (e.g., identifying the publisher that presented content related to the installation, such as content that the user selected to initiate the installation), a content identifier (e.g., an identification of a specific video or image), a content type (e.g., image, video, audio, computer game, etc.), a website identifier (e.g., identifying an app store or other website), a history of user interactions with content presentations (e.g., a record of clicks or other user selections on the client device), and any combination thereof. The user data 130 database generally includes information related to users of the client devices and/or the client application. Such information can include, for example, user device information (e.g., device ID, device type, IP address, user agent identifier), user location (e.g., city, state, and/or country), and/or a history of user interactions with the client application (e.g., clicks, messages, purchases, etc.). For example, when a user installs and begins using the client application on a client device, information related to the installation and/or use of the client application can be received by and stored in the user data 130 database. The attribution data 132 database generally includes information relating content presentations on client devices to user action taken on the client devices. For example, the attribution data 132 database can include data that attributes user action to one or more previous content presentations on the user's client device.

In general, digital content (e.g., from the presentation data 128 database) can be presented on the client devices using a plurality of publishers, which can include the publisher A module 125 and the publisher B module 126. Any suitable number of publishers and publisher modules are possible. Each publisher can be or include, for example, a website and/or a software application configured to present the content. When an item of content is presented on a client device, the user can interact with the content in multiple ways. For example, the user can view the content, select or click one or more portions of the content, play a game associated with the content, and/or take an action associated with the content. In certain instances, the action can be or include, for example, watching a video, viewing one or more images, selecting an item (e.g., a link) in the content, playing a game, visiting a web site, downloading additional content, and/or installing a software application. In some instances, the content can offer the user a reward in exchange for taking the action. The reward can be or include, for example, a credit to an account, a virtual item or object for an online computer game, free content, or a free software application. Other types of rewards are possible. In general, content that offers users a reward for taking an action (e.g., installing a software application or finishing an application tutorial) can be referred to herein as “incentivized content.” Additionally or alternatively, content that does not offer users a reward for taking an action can be referred to herein as “non-incentivized content.”

In various examples, the user action taken in response to a content presentation can be or include, for example, installing a software application, activating a software application, using a software application, reaching goals or milestones in the software application, making a purchase, generating revenue, and/or interacting with other users. Other types of user action are possible. The user action can alternatively be referred to herein as a “conversion.”

A software installation can occur when a user obtains a copy of software (e.g., via a download) and installs the software on the user's client device and/or begins using the installed software. The installed software can be or include, for example, a software program for a computer game (e.g., a multiplayer online game), business productivity (e.g., a word processor), weather, news, or any other purpose. The software program can be downloaded from a website, such as an app store.

When a software application is first installed and/or used, a record of the software installation can be provided (e.g., by the client device) to one or more server computers or similar components. The record can include, for example, a client device identifier (also referred to as device ID), an IP address (e.g., for the client device), a device geographical location (e.g., city, state, and/or country), a user agent identifier (e.g., a browser identifier), a timestamp (e.g., corresponding to a time at which the installation occurred), a publisher identifier (e.g., identifying the publisher that presented content related to the installation, such as content that the user selected to initiate the installation), a content identifier (e.g., an identification of a specific video or image), a content type (e.g., image, video, and/or audio), a website identifier (e.g., identifying an app store or other website from which the software was obtained), a history of user interactions with content presentations (e.g., a record of clicks or other user selections on the client device), a dupe IP address percentage, a conversion distribution, and any combination thereof. The record can identify or include other information. In some instances, records for multiple software installations can be provided in a stream of data. For example, one or more server computers can collect records from multiple client devices and/or publishers and distribute the records in a stream of data to other computer components, as described herein, preferably in real-time.

Additionally or alternatively, in some instances, the publishers of content can be rewarded based on actions taken by users in response to the displayed content. For example, when a user clicks or selects an item of content or takes a certain action (e.g., installs or begins using a software application) in response to the content, the publisher can receive a reward or compensation from an entity (e.g., a person or a company) associated with the content or the action. The reward or compensation can provide an incentive for the publisher to display the content.

In some instances, for example, a publisher can receive compensation when it presents an item of content on a client device and a user installs a software application (or takes a different action) in response to the content. The publisher can provide information to the collection module 116 (e.g., via the presentation data 128 database and/or the user data 130 database) indicating that the content was presented on the client device. Alternatively or additionally, the collection module 116 can receive an indication that the user selected the content and/or that the software application was installed. Based on the received information, the system 100 can attribute the software application installation to the item of content presented by the publisher and/or other items of content presented by other publishers. The publisher can receive the compensation based on this attribution.

In various examples, the system 100 can determine, based on information related to content presentations on client devices (e.g., in the presentation data 128 database and/or the user data 130 database), how to attribute user actions to the content presentations and/or the publishers of the content. In some instances, for example, a user can visit or use websites or software applications provided by publishers that present items of content at different times on the user's client device. When the user takes an action (e.g., installs a software application) in response to the content presentations, the system 100 may select one or more of the publishers to receive the credit or attribution for the action, as described herein. A selected publisher may be, for example, the publisher that was last to receive a click on the content before the user took the action. The selected publisher can receive compensation from an entity associated with the content or the action. Other publishers that presented the content and/or received clicks on the content may receive similar compensation or no compensation.

This scheme in which publishers can receive compensation based on attribution for user actions can result in fraudulent publisher activity. For example, a fraudulent publisher can send incorrect or misleading information to the collection module 116 (e.g., via the presentation data 128 database and/or the user data 130 database) in an effort to fool the system 100 into attributing user action to content presented by the publisher. The fraudulent publisher can, for example, provide information to the collection module 116 indicating that the content was displayed on the user's client device when the content was not in fact displayed. Additionally or alternatively, the fraudulent publisher can provide information to the collection module 116 indicating that the user interacted with the content (e.g., clicked on the content, or installed software in response to the content) when such interactions did not occur.

Fraudulent or false clicks or installations can occur in various scenarios. For example, technical integration issues among computer systems can result in false clicks or installations. Such integration issues can cause, for example, a presentation of content to be erroneously counted as a click on the content. Alternatively or additionally, a fraudulent publisher can generate a high volume of false random clicks or evenly spaced clicks in an effort to steal attribution from legitimate publishers. Fraudulent publishers can also drive fake attribution postbacks with machine-generated device IDs or fingerprints in an effort to win attributions by chance. Fraudulent publishers can also use bots or automated machines to click on content, with little or no human interaction. Bots can also be used to drive fraudulent installs from the same geographical location, via a virtual private network (VPN), via mobile device emulators on desktop, and/or with cheap and obsolete devices. In some cases, malicious software can be used to hijack a client device and use cookies to mimic the user's viewing and clicking behavior. Alternatively or additionally, publishers can hide content (e.g., under other displayed content) and can count user clicks on visible items as clicks on the hidden content.

Fraudulent or false clicks or installations can occur in other scenarios. For example, a fraudulent publisher can mix or mislabel incent traffic (e.g., records of incentivized software installations) into non-incent traffic (e.g., records of non-incentivized software installations) in an effort to make non-incentivized content presentations show relatively decent but short-term only post-install engagements. Additionally or alternatively, a fraudulent publisher can use bots to complete minimum software engagement requirements associated with incentivized content presentations (e.g., for an online game application). This can allow the publisher to receive a reward when the minimum engagement requirements are met. In some instances, a fraudulent publisher can retarget and incentivize old users to complete certain levels of engagement for rewards. Such users can be of limited value to software developers and providers.

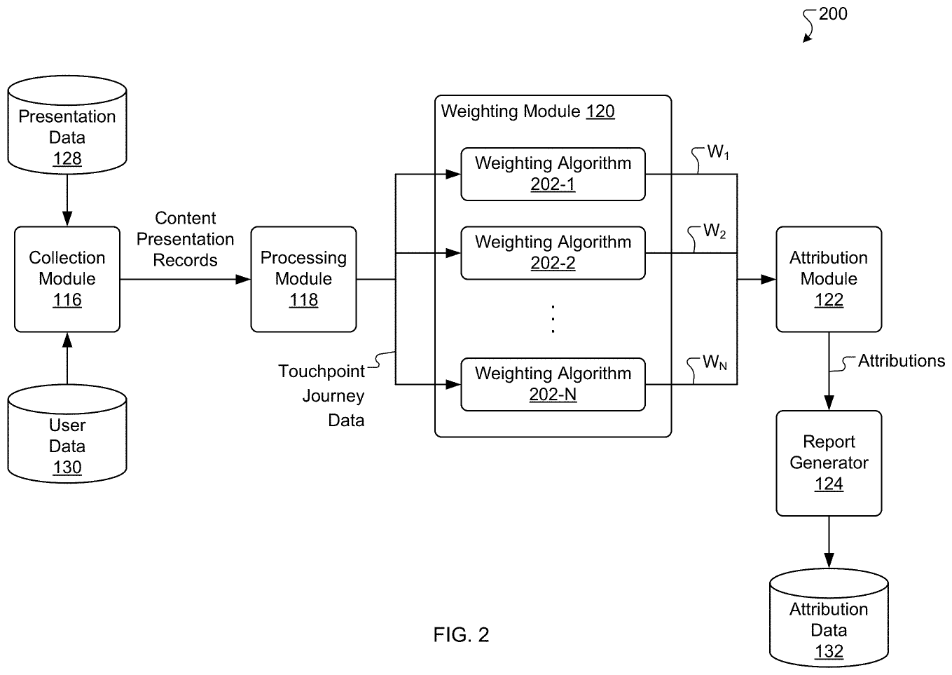

Referring to FIG. 2, in various examples, a system 200 for managing content presentations on client devices includes the collection module 116, the processing module 118, the weighting module 120, the attribution module 122, and the report generator 124. The collection module 116 can receive data related to the content presentations from the presentation 128 database and/or the user data 130 database. The data can be or include, for example, a record of the content presentations on the client devices and any user actions taken on the client devices (e.g., software installations and/or interactions with the client application). The data can be a live data stream, such that data for content presentations and/or user actions can be received immediately or shortly (e.g., within seconds or minutes) after the content is presented and/or user actions are taken. In some instances, the data can be provided to the presentation data 128 database and/or the user data 130 database by one or more publishers, such as the publisher A module 125 and the publisher B module 126, and/or a provider or manager of the client application or other software application.

The content presentation data or records can be provided from the collection module 116 to the processing module 118. The processing module 118 can cleanse the content presentation data to remove any erroneous data or handle any missing or inaccurate data. Additionally or alternatively, the processing module 118 can aggregate the content presentation data by client device (e.g., by device identifier), such that content presentation data for each individual client device can be extracted and/or separated from other content presentation data. In some instances, for example, the processing module 118 can output a touchpoint journey for one or more client devices. The touchpoint journey for a client device can be or include, for example, a history or sequence of content presentations and/or user interactions with the content presentations that relate to an action taken by a user on the client device. For example, when the user action is initiating a software installation, the touchpoint journey can include a history of content presentations that relate to the software and precede the software installation. Each content presentation in the touchpoint journey can be or include, for example, a content presentation that encouraged the user to install the software application. In preferred examples, the touchpoint journey for a client device can be or include a record of content presentations that includes a time (e.g., a timestamp), a date, a publisher, a content identifier, a content type (e.g., video or image), and/or a content presentation campaign for each content presentation. Additionally or alternatively, the record can include information related to any clicks or other user interactions with each content presentation.

The touchpoint journey data for a client device can be provided by the processing module 118 to the weighting module 120, which can process the touchpoint journey data using one or more weighting algorithms. In the depicted example, the weighting module 120 includes N weighting algorithms 202-1, 202-2, . . . , 202-N, where N can be any integer but is preferably 2, 3, 4, or higher. Each weighting algorithm 202-1, 202-2, . . . , 202-N can receive the touchpoint journey data as input and provide as output a set of weights W₁, W₂, . . . , W_{N}, respectively, for the touchpoint journey. Each set of weights W₁, W₂, . . . , W_{N} can include one weight for each content presentation in the touchpoint journey. For example, the first set of weights W₁ can include one weight for each content presentation in the touchpoint journey, as determined by the first weighting algorithm 202-1. In general, a weight for a content presentation provides an indication of an influence that the content presentation had on the user. More particularly, the weight can indicate how influential the content presentation was on the user's decision to take the user action. In preferred examples, each weighting algorithm can output a unique set of weights for the touchpoint journey. The weights in each set of weights W₁, W₂, . . . , W_{N} can have a sum of 1.0 or 100%. Larger weights can correspond to content presentations that were more influential, while smaller weights can correspond to content presentations that were less influential.

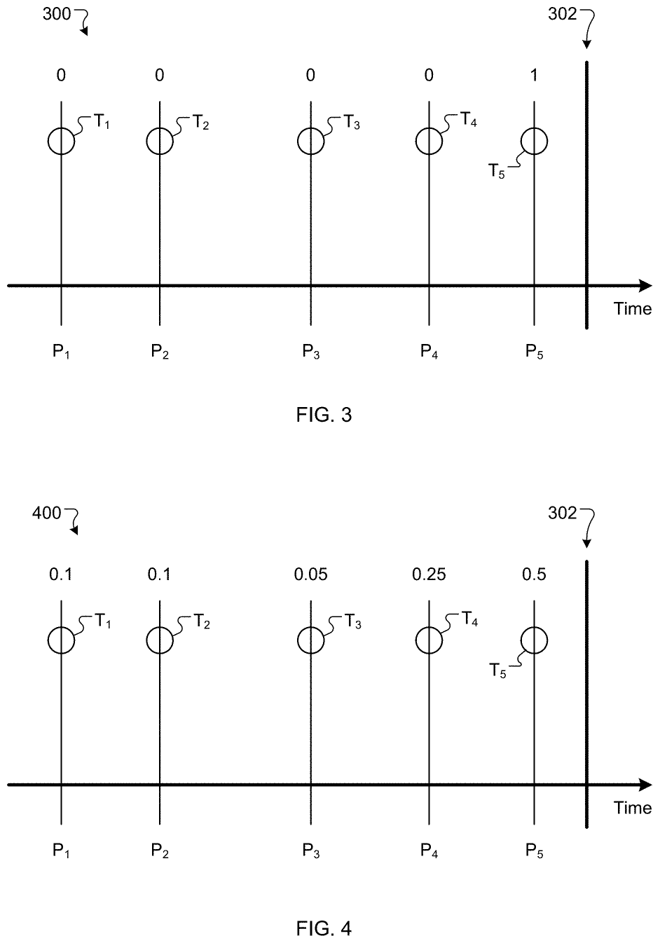

For example, FIG. 3 includes a timeline for an example touchpoint journey 300 in which a user experienced five content presentations P₁, P₂, P₃, P₄, and P₅, corresponding to touchpoints T₁, T₂, T₃, T₄, and T₅, respectively, prior to taking a user action 302. Each content presentation may have been provided by a unique publisher, such that five separate publishers provided the five content presentations P₁, P₂, P₃, P₄, and P₅. Alternatively, more than one content presentation (e.g., all five presentations P₁, P₂, P₃, P₄, and P₅) may have been provided by a single publisher. A weight for each content presentation is provided above each touchpoint. In the depicted example, the weights for the touchpoints T₁, T₂, T₃, T₄, and T₅ are 0, 0, 0, 0, and 1, respectively. In this case, one or more weighting algorithms (or a combination thereof) determined that the user was influenced to take the user action 302 solely by the final touchpoint T₅. The other touchpoints T₁, T₂, T₃, and T₄ were determined to have no influence on the user. This approach in which the last touchpoint receives all the attribution for the user action 302 can be referred to as last-touch attribution (LTA). In general, LTA can be an inaccurate approach for attributing user action to touchpoints. It is generally not true, for example, that a user is driven to take an action solely by the last touchpoint in a touchpoint journey having multiple touchpoints. The LTA approach can also be susceptible to fraud. For example, a publisher can attempt to earn attribution by providing the last touchpoint through fraudulent means (e.g., fake impressions or clicks).

By contrast, FIG. 4 includes a timeline for a similar touchpoint journey 400 in which the weights for the touchpoints T₁, T₂, T₃, T₄, and T₅ are 0.1, 0.1, 0.05, 0.25, and 0.5, respectively. In this case, one or more weighting algorithms (or a combination thereof) determined that each touchpoint in the touchpoint journey 400 played a role in encouraging the user to take the user action 302. The most influential touchpoint in this example was touchpoint T₅, which immediately preceded the user action 302 and has a weight of 0.5. The other touchpoints T₁, T₂, T₃, and T₄ have a combined weight of 0.5, with touchpoint T₄ having the second highest weight (0.25) among the touchpoints. As the figure indicates, the systems and methods described herein can assign a fractional weight or attribution to each content presentation in the touchpoint journey. This allows the user action 302 to be attributed to multiple touchpoints within the touchpoint journey 400. This approach in which multiple touchpoints receive a portion or fraction of the attribution for the user action 302 can be referred to herein as multi-touch attribution (MTA).

Referring again to FIG. 2, each weighting algorithm in the weighting module 120 can utilize or include a separate or distinct model for determining the set of weights for the touchpoint journey. In some instances, a weighting algorithm can determine weights based on, for example, the times at which each item of content was presented (e.g., relative to the user action), indications that one or more content presentations were associated with fraud (e.g., from a fraudulent publisher), a type of content (e.g., image, video, playable content, game content, text, incentivized, etc.) associated with each content presentation, and/or a type of bid associated with a content presentation campaign (e.g., cost-per-click or cost-per-install). The weighting algorithms can capture different aspects of a digital marketing funnel, ranging from front-end based metrics, such as, for example, touchpoint positioning, campaign type, etc., to backend based metrics, such as, for example, revenue growth, level complete rate, etc. Other approaches for determining the weights are possible.

For example, at least one of the weighting algorithms can utilize time-based weighting. In general, the time from a touchpoint to the user action in a user's touchpoint journey can be an informative signal to assess the underlying importance of the touchpoint. If a touchpoint occurs in a relatively short time interval (e.g., less than one hour) before the user action, for example, the importance of that particular touchpoint in driving the user action can be considered high. On the other hand, if a touchpoint occurs in a relatively large time interval (e.g., greater than one hour, one day, or one week) before the user action, the importance of that particular touchpoint can be considered low.

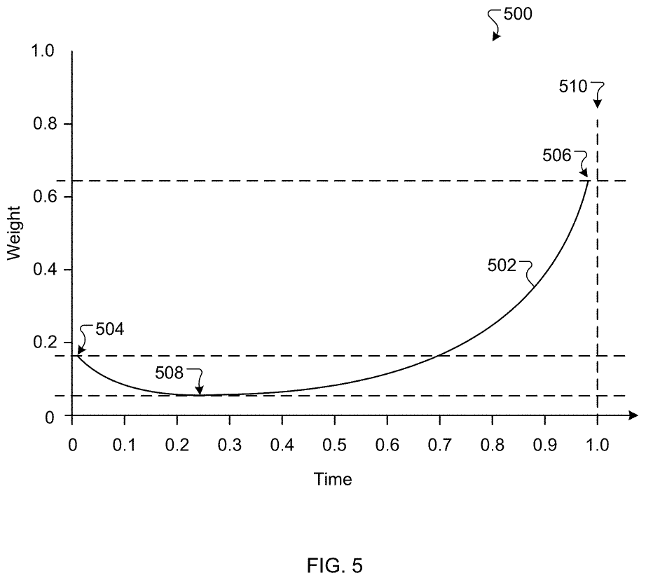

For example, FIG. 5 includes a plot 500 of a functional form 502 that can be used to determine weights for touchpoints based on times at which the touchpoints occurred. The functional form 502 in this example has a local maximum at a first endpoint 504, a local maximum at a second endpoint 506, and a minimum value 508 between the first endpoint and the second endpoint. The functional form 502 can be mapped to a touchpoint journey, such that the first endpoint 504 can correspond to a first touchpoint, the second endpoint 506 can correspond to a last touchpoint (e.g., before a user action 510), and middle portions of the functional form 502 can correspond to intermediate touchpoints, according to times at which the intermediate touchpoints occurred. With this approach, the functional form 502 can be used to assign weights to the first and last touchpoints that are higher than weights for the intermediate touchpoints. In the depicted example, the weight for the last touchpoint can be higher than the weight for the first touchpoint, given that the value of the functional form 502 is highest at the second endpoint (corresponding to the last touchpoint). The functional form can be defined or approximated using, for example, a beta distribution, a parabola, or similar function.

In various examples, the magnitudes of the functional form 502 at the first endpoint 504 and the second endpoint 506 can be determined based on a time difference between the two endpoints 504 and 506 and/or based on a time difference between the second endpoint 506 and the user action 510. For example, when the user action 510 occurs shortly after the second endpoint, the last touchpoint likely had a large influence on the user, and the magnitude of the functional form 502 at that second endpoint 506 can be set to a high value or a relatively high value. Additionally or alternatively, when the time difference between the two endpoints 504 and 506 is large (e.g., several days or weeks), the last touchpoint was likely much more influential than the first touchpoint, and the functional form 502 can be defined to have a higher value at the second endpoint 506 than at the first endpoint 504. By contrast, when the time difference between the two endpoints 504 and 506 is small (e.g., a few minutes or hours), the first and last touchpoints likely had a similar influence on the user, and the functional form 502 can be defined to have similar values at the two endpoints 504 and 506.

In general, the functional form 502 can be tailored to assign weights in a manner that corresponds to how users are typically influenced by a sequence of content presentations. In a typical example, users can be most highly influenced by the touchpoint immediately preceding the user action 510. The second most influential touchpoint can correspond to the first touchpoint. Touchpoints between the first and last touchpoints are typically less influential. These observations are consistent with the functional form 502 having higher values near the endpoints and lower values in the middle. The shape of the functional form 502 can be modified, for example, by adjusting values of the functional form 502 at the first endpoint 504, at the second endpoint 506, and/or at the minimum 508. Additionally or alternatively, a time at which the minimum value 508 occurred can be adjusted.

In some examples, at least one of the weighting algorithms can utilize fraud-based weighting. Such an algorithm can determine and/or consider a fraudulent intent of a touchpoint and assign weights appropriately. To this end, a fraud detection suite can be used to assign fraud penalty scores to various touchpoints. Touchpoints that are known to be associated with fraud (e.g., fraudulent publishers) or are suspected of being associated with fraud can be assigned low weights (e.g., zero, 0.1, or 0.25). In general, a high likelihood of fraud can result in a low weight (e.g., zero), while a low likelihood of fraud can result in a high weight (e.g., 0.9 or 1.0). Various types of fraud can be detected using a wide variety of techniques. Methods of detecting fraud associated with content presentations are described in U.S. Patent Application Publication No. 2019/0057197, published on Feb. 21, 2019, U.S. Patent Application Publication No. 2019/0057009, published on Feb. 21, 2019, U.S. Patent Application Publication No. 2019/0087764, published on Mar. 21, 2019, and U.S. Patent Application Publication No. 2019/0102545, published on Apr. 4, 2019, the entire contents of each of which are incorporated by reference herein.

Additionally or alternatively, at least one of the weighting algorithms can utilize campaign-type weighting. One example of a content presentation campaign type is cost-per-install (CPI), in which each software install driven by a content presentation can be payable. In this case, for example, when the software install is attributed to an item of content presented by a publisher, the publisher can receive a payment or other compensation. Another example of a content presentation campaign type is cost-per-event (CPE), in which a post-install event completion is payable. For example, a publisher can receive a payment or other compensation when a user reaches an event or milestone in a software application (e.g., level 10 in a multiplayer online game). Another content presentation campaign type is cost-per-click, in which each click on content can be payable. Other types of content presentation campaigns can be considered. The efficacy of different campaigns in driving a user event or conversion can vary considerably. Given that a single touchpoint journey for a user can include touchpoints driven from different types of campaigns, it can be important to account for a wide range of campaign types. To account for this, the weights for campaign types can be determined based on long-term performance of users driven by different campaign types. The algorithm can incorporate or utilize such information when assigning weights.

Additionally or alternatively, one or more of the algorithms can utilize content type weighting, in which weights are assigned according to a type of content presented. Certain types of content (e.g., games, videos, or incentivized content) may have a greater influence on users than other types of content (e.g., images, text, or non-incentivized content). To account for such differences, content types that are known (e.g., based on historical performance) to be more influential can be assigned higher weights, while content types that are known to be less influential can be assigned lower weights.

Still referring to FIG. 2, once the weighting algorithms 202-1, 202-2, . . . , 202-N have provided corresponding sets of weights W₁, W₂, . . . , W_{N} for a touchpoint journey, the attribution module 122 can process the weights W₁, W₂, . . . , W_{N} to determine an attribution value for each touchpoint in the touchpoint journey. The attribution value for a touchpoint can provide a final indication of how much credit the touchpoint should receive for driving or encouraging the user to take the user action. In preferred examples, the attribution module 122 can use advanced ensemble learning methods to combine the weights W₁, W₂, . . . , W_{N} into a set of aggregate weights, with one aggregate weight for each touchpoint. The weights W₁, W₂, . . . , W_{N} can be combined in various ways, for example, using statistics, averaging, weighted averaging, multiplication, and/or addition. In some examples, the attribution values can be determined by calculating averages (e.g., weighted averages) of the weights W₁, W₂, . . . , W_{N} from the weighting algorithms. For example, the attribution value for a touchpoint can be an average of the weights for that touchpoint. By using weighted averages, the attribution module 122 can give greater significance or weight to the output from one or more of the weighting algorithms. For example, a significance can be assigned to each weighting algorithm, and the weights W₁, W₂, . . . , W_{N} can be combined (e.g., in a weighted average) according to the assigned significance for each weighting algorithm.

Table 1 presents example weights for a touchpoint journey having five touchpoints and three sets of weights W₁, W₂, and W₃. To determine an aggregated weight or attribution value for each touchpoint in this example, the three weights for each touchpoint were multiplied together to obtain a product for each touchpoint. Each product was then multiplied by a constant (in this case 17.54) to obtain a set of attribution values that add up to 1.0. The results in Table 1 indicate that touchpoint 5 had the greatest influence, followed by touchpoints 1, 3, 4, and 2.

TABLE 1
Weights and attribution values for an example touchpoint journey.

| Touchpoint | W₁ | W₂ | W₃ | Attribution |
|---|---|---|---|---|
| 1 | 0.25 | 0.3 | 0.3 | 0.395 |
| 2 | 0.25 | 0.1 | 0 | 0 |
| 3 | 0.1 | 0.1 | 0.3 | 0.053 |
| 4 | 0.15 | 0.1 | 0.1 | 0.026 |
| 5 | 0.25 | 0.4 | 0.3 | 0.526 |
| Total | 1 | 1 | 1 | 1 |

In some examples, the attribution module 122 can use one or more interpolators, classifiers, or machine-learning models or techniques to determine the attribution values from the sets of weights W₁, W₂, . . . , W_{N}. The classifiers or machine-learning models can be or include, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests), neural networks, and/or learning vector quantization models. Other classifiers can be used. Once trained, the one or more classifiers can receive sets of weights as input and can provide attribution values or aggregated weights as output.

Still referring to FIG. 2, the attribution values from the attribution module 122 can be provided to a report generator module 124, which can write the attribution values to the attribution data 132 database and generate a report based on the attribution values. In some instances, for example, the report generator module 124 can provide recommendations for future content presentations on client devices and can initiate changes to future content presentations. For example, the report can identify publishers and/or items of content that are associated with high attribution values. Such publishers and/or items of content can be recommended for use again in the future (e.g., at a similar or higher frequency). Likewise, the report can identify publishers and/or items of content that are associated with low attribution values. Such publishers and/or items of content can be recommended for little or no use in the future. In various examples, users of the systems and methods described herein can use the report to facilitate or implement changes to content presentations based on the attribution values and/or report recommendations. In some instances, for example, a return on investment can be determined based on the attribution values, costs associated with the content presentations, and/or revenue generated based on the user action. The return on investment can be used to make adjustments to future use of specific publishers, content distributors or providers, and/or specific items of content.

In general, the attribution values can be used for a wide variety of downstream processes. For example, the attribution values can be used for media buying budget allocation. At the core of successful media buying, a media buyer can rely on an intelligent allocation of budget to different media sources. To do this effectively, it can be imperative to have an accurate understanding of the value a media source drives, which can be provided by the attribution values. Additionally or alternatively, the attribution values can be used to optimize content presentation campaigns. Effective media buying campaigns can be driven by an acute understanding of the value driven by the campaigns, which can be determined using the attribution system and methods described herein.

In general, media buying can be a complex space involving content presentation networks, demand-side platforms (DSPs), offerwall and mobile-web content providers, etc., which can serve content and/or offers (e.g., ads) to users. A single user is likely to be served multiple items of content from various channels before the user takes a desired action (e.g., becomes an acquired user of a software application). For example, the user may be served a first offer while the user is browsing a web page and a second offer while the user is playing a game (e.g., targeted by a DSP or an Offerwall). Given such a setting, an accurate attribution of the acquired user to a particular media source or item of content can be of utmost importance. The LTA approach, described herein, can attribute the conversion to the publisher or other media source responsible for the last touchpoint, as indicated in FIG. 3. To make such a system robust, scalable and applicable to different types of media sources, waterfall attribution logic can be used. With such an approach, touchpoints in a user touchpoint journey can be prioritized based on the type of device identifiers available. For instance, a click with only an IP address can be prioritized below a click with a device ID. Such an attribution system can provide a reasonable first step towards understanding the efficacy of different media sources. There are, however, multiple shortcomings of such a system.

For example, the LTA model can be based on an assumption that a single touchpoint is enough to drive conversion. Based on analysis of various datasets, however, it is more common for a user to see multiple touchpoints before the conversion occurs. Any attribution model focusing on just one touchpoint can end up undervaluing the importance of the other touchpoints involved in a user touchpoint journey.

Further, the LTA model can allow fraudsters to more easily game the system. For instance, fraudsters can develop malware and can drive fake touchpoints when the fraudsters detect a conversion (e.g., an app is being downloaded, installed, or activated), in an effort to become the last touch. Additionally, fraudsters can illegitimately and randomly spray content presentations and/or clicks on content, hoping to get the last touch. As a result, touchpoints truly responsible for user action may not earn their due credit.

Additionally or alternatively, certain types of content (e.g., playable content or video content) can be much more likely to lead to conversion than other types of content (e.g., images or banners). The LTA approach, however, generally involves no weighing of touchpoints by content type or other feature. This can lead to high engagement content getting under weighted.

In various examples, the efficacy of content presentation campaigns may need to be evaluated on a continuous basis, and accurate attribution systems can play a key role in campaign assessments. Advantageously, the systems and methods described herein are able to leverage novel algorithms and big data platforms to derive accurate attribution to different content presentations, publishers, and other media sources, thereby helping content presenters or media buyers take action that can improve the efficacy of the content presentations. Moreover, compared to the LTA approach, the fractional, data driven attribution system described herein is generally far less susceptible to fraudulent activities. The multi-touch attribution system described herein is less likely to be impacted by fraudulent activities, such as click injection, click spamming, and the like, given that user action is generally not attributed to a single touchpoint.

In various examples, the systems and methods described herein (e.g., involving the weighting module 120 and/or the attribution module 122) can utilize ensemble learning and/or machine learning algorithms to learn the impact of each touchpoint and infer attribution values for multiple touchpoints. The systems and methods are configured to be modular and extensible, for example, by allowing additional or new weighting algorithms to be incorporated into the weighting module 120. The systems and methods can make use of batch processing to surface attribution values in a timely manner. For example, touchpoint journey data can be processed in separate batches, with one batch for each client device or corresponding conversion. The systems and methods can be run on an hourly, daily, or weekly basis (or other suitable frequency), using the most recent historical data.

The systems and methods described herein preferably can employ a multi-dimensional, holistic approach to derive a weight for each touchpoint in a touchpoint journey. Various weighting algorithms can analyze the touchpoint journey from multiple viewpoints, including, but not limited to, position of touchpoint in the journey (e.g., based on time from the user action), fraud (e.g., publisher fraud), quality of media type, content presentation campaign type, and the like.

As described herein, content presentation data can be analyzed to determine attribution values at the device level, for example, by calculating attribution values for a touchpoint journey on a client device. Advantageously, such use of device-level attribution for touchpoint journeys can enable media buyers (e.g., content developers or providers) to carry out arbitrary level aggregation, thereby allowing the media buyers to gain a deeper understanding of content presentation effectiveness. For example, device-level attribution values can be aggregated by content presentation campaign (e.g., using a campaign identifier), to gauge how well content presentation campaigns are performing across multiple client devices. To understand the extent of incrementality driven by a campaign, for example, a media buyer can count the number of conversions (e.g., software installs) across multiple campaigns, particularly campaigns that overlap or that drive similar conversion events (e.g., installing the same software applications). The media buyer can then determine a ratio of a number of conversions for a single campaign to a number of conversions across all campaigns driven by the media buyer. This can enable the media buyer to understand an incremental impact that each campaign has on the total number of conversions. For example, a media buyer could determine how the total number of conversions would change if one of the campaigns were eliminated. This change, referred to as a removal effect, can allow media buyers to determine which campaigns are of greatest value and should be maintained and which campaigns are of least value and should be eliminated or revised.

In various examples, the systems and methods described herein can generate fractional weights and/or attribution values for attributing each touchpoint in a user's touchpoint journey. The approach can allow an incremental value driven by each touchpoint to be determined and evaluated. The determined attribution values can allow for a more accurate calculation of various performance indicators, including, for example, a click-to-install ratio, an engagement rate, a number of content presentations (also referred to as impressions), a number of content selections (also referred to as clicks), a number of engagements with a software application, a number of software application installs, a number of conversions (e.g., purchases or offer acceptances), a time-to-install (e.g., an elapsed time between a content presentation and a software installation), and/or any combination thereof. Other performance indicators are possible. Each performance indicator can be calculated for a period of time, such as a previous hour, day, or week. The performance indicators can be updated or recalculated as additional information is collected over time. Some performance indicators can be specific to client devices, while other KPIs can be specific to publishers.

Additionally or alternatively, the systems and methods described herein can take into account various weighting schemes and produce an ensemble learning mechanism in a statistical manner. By continually using new data to update and/or train the algorithms and ensemble learning methods, the systems and methods are able to stay current and up to speed with a constantly evolving content presentation marketplace.

To extract actionable insights from big data, it can be important in some examples to leverage big data technologies, so that there is sufficient support for processing large volumes of data. Examples of big data technologies that can be used with the systems and methods described herein include, but are not limited to, APACHE HIVE and APACHE SPARK. In general, APACHE HIVE is an open source data warehousing infrastructure built on top of HADOOP for providing data summarization, query, and analysis. APACHE HIVE can be used, for example, as part of the processing module 118 to generate and/or process the content presentation records and touchpoint journey data. APACHE SPARK is, in general, an open source processing engine built around speed, ease of use, and sophisticated analytics. APACHE SPARK can be leveraged to detect abnormal deviations in a scalable and timely manner. APACHE SPARK can be used, for example, for data preprocessing and/or for calculating similarity statistics. In general, the real-time capabilities of the systems and methods described herein can be achieved or implemented using APACHE SPARK or other suitable real-time platforms that are capable of processing large volumes of real-time data.

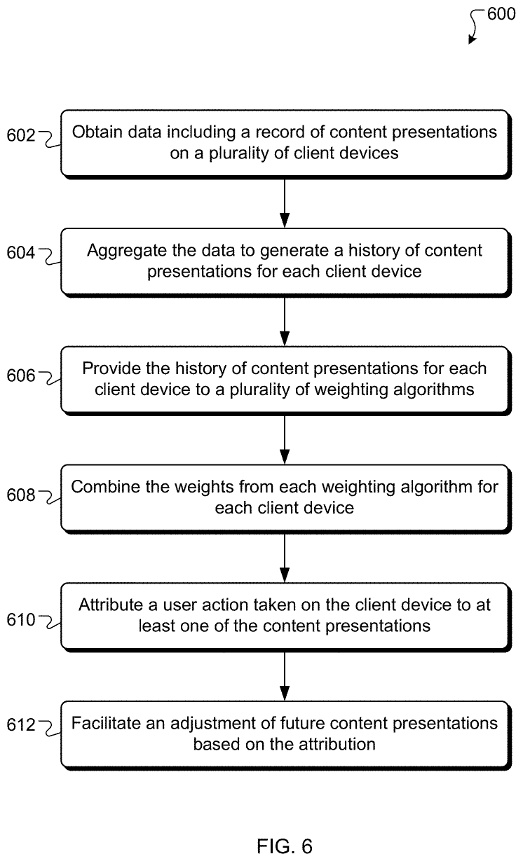

FIG. 6 illustrates an example computer-implemented method 600 of managing content presentations on client devices. Data is obtained (step 602) that includes a record of content presentations on a plurality of client devices. The data is aggregated (step 604) to generate a history of content presentations for each client device from the plurality of client devices. The history of content presentations for each client device is provided (step 606) to a plurality of weighting algorithms. Each weighting algorithm is configured to calculate a weight for each content presentation in the history of content presentations. Each weight includes an indication of an influence the content presentation had on a user of the client device. The weights from each weighting algorithm are combined (step 608) for each client device. Based on the combined weights for each client device, a user action taken on the client device is attributed (step 610) to at least one of the content presentations. An adjustment of future content presentations is facilitated (step 612) based on the attribution.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
obtaining data comprising a record of content presentations on a plurality of client devices;
aggregating the data to generate a history of content presentations for each client device from the plurality of client devices;
providing the history of content presentations for each client device to a plurality of weighting algorithms, each weighting algorithm configured to calculate a weight for each content presentation in the history of content presentations, each weight comprising an indication of an influence the content presentation had on a user of the client device;
combining the weights from each weighting algorithm for each client device;
attributing, based on the combined weights for each client device, a user action taken on the client device to at least one of the content presentations; and
facilitating an adjustment of future content presentations based on the attribution.

2. The method of claim 1, wherein the data comprises an identification of an item of content and a time at which the identified item of content was presented on a client device from the plurality of client devices.

3. The method of claim 2, wherein the data further comprises an identification of user interactions with the content presentations.

4. The method of claim 1, wherein at least one weighting algorithm from the plurality of weighting algorithms is configured to calculate at least one of the weights according to a time difference between at least one of the content presentations and the user action taken on the client device.

5. The method of claim 1, wherein at least one weighting algorithm from the plurality of weighting algorithms is configured to calculate at least one of the weights according to a time difference between a first content presentation and a last content presentation in the history of content presentations.

6. The method of claim 1, wherein at least one weighting algorithm from the plurality of weighting algorithms is configured to calculate the weight for each content presentation according to an indication of fraud associated with the content presentation.

7. The method of claim 1, wherein at least one weighting algorithm from the plurality of weighting algorithms is configured to calculate the weight for each content presentation according to a type of content associated with the content presentation, and wherein the type of content comprises one of image content, video content, or playable content.

8. The method of claim 1, wherein combining the weights comprises:
assigning a significance to each weighting algorithm; and
combining the weights according to the assigned significance for each weighting algorithm.

9. The method of claim 1, wherein the user action comprises:
initiating a software installation on the client device.

10. The method of claim 1, wherein attributing the user action to at least one of the content presentations comprises:
determining a fractional attribution for each content presentation in the at least one of the content presentations, wherein the fractional attribution comprises an indication of how much the content presentation in the at least one of the content presentations influenced the user to take the action.

11. A system, comprising:
one or more computer processors programmed to perform operations comprising:
obtaining data comprising a record of content presentations on a plurality of client devices;
aggregating the data to generate a history of content presentations for each client device from the plurality of client devices;
providing the history of content presentations for each client device to a plurality of weighting algorithms, each weighting algorithm configured to calculate a weight for each content presentation in the history of content presentations, each weight comprising an indication of an influence the content presentation had on a user of the client device;
combining the weights from each weighting algorithm for each client device;
attributing, based on the combined weights for each client device, a user action taken on the client device to at least one of the content presentations; and
facilitating an adjustment of future content presentations based on the attribution.

12. The system of claim 11, wherein the data comprises an identification of an item of content and a time at which the identified item of content was presented on a client device from the plurality of client devices.

13. The system of claim 12, wherein the data further comprises an identification of user interactions with the content presentations.

14. The system of claim 11, wherein at least one weighting algorithm from the plurality of weighting algorithms is configured to calculate at least one of the weights according to a time difference between at least one of the content presentations and the user action taken on the client device.

15. The system of claim 11, wherein at least one weighting algorithm from the plurality of weighting algorithms is configured to calculate at least one of the weights according to a time difference between a first content presentation and a last content presentation in the history of content presentations.

16. The system of claim 11, wherein at least one weighting algorithm from the plurality of weighting algorithms is configured to calculate the weight for each content presentation according to an indication of fraud associated with the content presentation.

17. The system of claim 11, wherein at least one weighting algorithm from the plurality of weighting algorithms is configured to calculate the weight for each content presentation according to a type of content associated with the content presentation, and wherein the type of content comprises one of image content, video content, or playable content.

18. The system of claim 11, wherein combining the weights comprises:
assigning a significance to each weighting algorithm; and
combining the weights according to the assigned significance for each weighting algorithm.

19. The system of claim 11, wherein attributing the user action to at least one of the content presentations comprises:
determining a fractional attribution for each content presentation in the at least one of the content presentations, wherein the fractional attribution comprises an indication of how much the content presentation in the at least one of the content presentations influenced the user to take the action.

20. An article, comprising:
a non-transitory computer-readable medium having instructions stored thereon that, when executed by one or more computer processors, cause the computer processors to perform operations comprising:
obtaining data comprising a record of content presentations on a plurality of client devices;
aggregating the data to generate a history of content presentations for each client device from the plurality of client devices;
providing the history of content presentations for each client device to a plurality of weighting algorithms, each weighting algorithm configured to calculate a weight for each content presentation in the history of content presentations, each weight comprising an indication of an influence the content presentation had on a user of the client device;
combining the weights from each weighting algorithm for each client device;
attributing, based on the combined weights for each client device, a user action taken on the client device to at least one of the content presentations; and
facilitating an adjustment of future content presentations based on the attribution.
